(19) United States
(12) Patent Application Publication
(10) Pub. No.: US 2010/0115929 A1
(43) Pub. Date: May 13, 2010

(54) CURRENT LIMITING DRIVER FOR ELECTRIC AIR PUMP

(75) Inventors: Kevin R. Liske, Sterling Heights, MI (US); David Kaitschuck, Commerce Township, MI (US); Todd R. Peterson, New Boston, MI (US)

Correspondence Address: WARN, HOFFMANN, MILLER & OZGA, P.C., P.O. BOX 70098, ROCHESTER HILLS, MI, 48307, US

(73) Assignee: BORGWARNER INC., Auburn Hills, MI (US)

(21) Appl. No.: 12/532,653

(22) PCT Filed: Mar. 27, 2008
(86) PCT No.: PCT/US2008/004040

§ 371 Date: Sep. 23, 2009

Related U.S. Application Data
(60) Provisional application No. 60/920,161, filed on Mar. 27, 2007.

(51) Int. Cl. F01N 3/22; F04B 17/03; H02P 1/18; F01N 3/32

(52) U.S. Cl. 60/289; 417/410.1; 318/430

(57) ABSTRACT

The present invention relates to a secondary air supply arrangement having an actuator operably connected to an air pump for creating air flow between an inlet and outlet of the air pump. A pulse width modulated controller is operably connected to the actuator for applying a pulse width modulated voltage to the actuator. The pulse width modulated controller controls the initial in-rush electric current when the actuator is activated.

### CROSS-REFERENCE TO RELATED APPLICATIONS

This application is a PCT International Application which claims the benefit of U.S. Provisional Application No. 60/920,161, filed Mar. 27, 2007. The disclosure of the above application is incorporated herein by reference.

### FIELD OF THE INVENTION

The present invention relates to a current limiting arrangement for a vehicle secondary air supply system.

### BACKGROUND OF THE INVENTION

When an engine goes through a cold start condition a secondary air supply device can be used to inject air into the engine's exhaust manifold. This allows oxygen to be introduced to the exhaust and cause excess hydrocarbons to be combusted. This also helps the catalytic converter achieve optimal temperature in a shorter amount of time.

Using secondary air supply devices can cause electric current surges into an actuator of an air pump when the actuator is initially energized from the cold start condition. This power surge is known as in-rush current. A surge of in-rush current into the actuator can cause undesirable conditions in the vehicle electrical system. Therefore, it is desirable to develop a current limiting arrangement wherein the actuator of the secondary air supply device is operably connected to a pulse width modulated controller to control the in-rush current.

### SUMMARY OF THE INVENTION

The present invention relates to a secondary air supply arrangement having an actuator operably connected to an air pump for creating air flow between an inlet and outlet of the air pump. A pulse width modulated controller is operably connected to the actuator for applying a pulse width modulated voltage to the actuator. The pulse width modulated controller controls the initial in-rush electric current when the actuator is activated.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of the secondary air supply arrangement having the pulse width modulated controller connected remotely;

FIG. 2 is a perspective view of the secondary air supply arrangement having the pulse width modulated controller mounted to the air pump;

FIG. 3 is an exploded view of the secondary air supply arrangement having the pulse width modulated controller integrated within the actuator;

FIG. 4 is a schematic diagram showing a current limiting arrangement;

FIG. 5a is a line graph illustrating the implications of in-rush current when no pulse width modulation is applied; and

FIG. 5b is a line graph showing the current controlled when the actuator of the secondary air supply arrangement is operably connected to the pulse width modulated controller.

### DETAILED DESCRIPTION OF THE PREFERRED EMBODIMENTS

The following description of the preferred embodiment(s) is merely exemplary in nature and is in no way intended to limit the invention, its application, or uses.

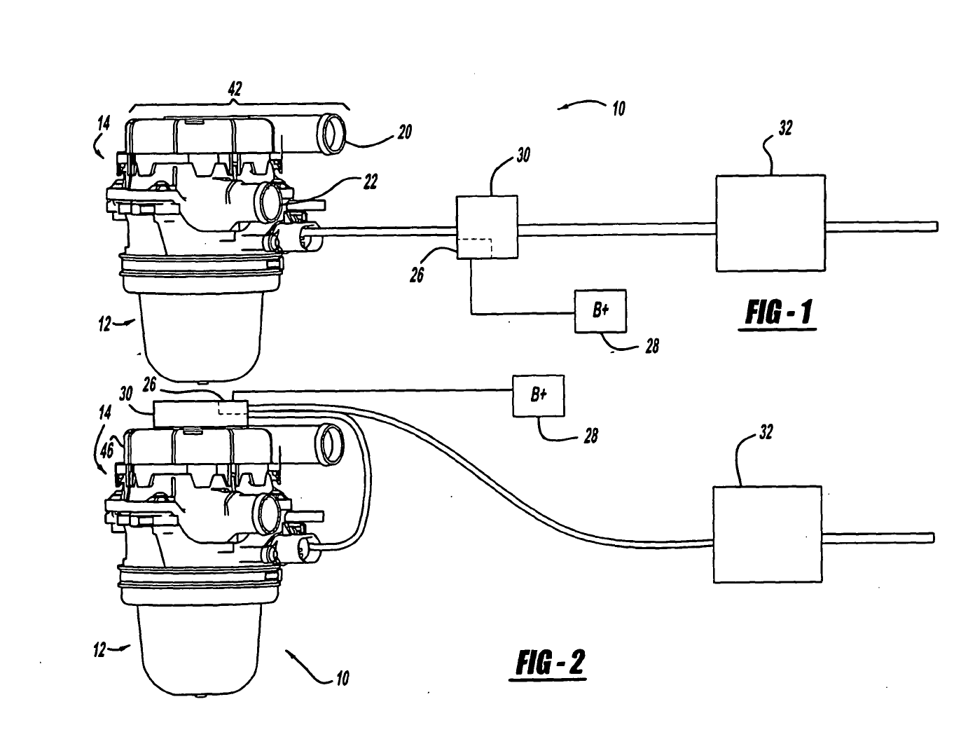

Referring generally to FIGS. 1-4 a secondary air supply arrangement is generally shown at 10 wherein the actuator generally shown at 12 receives electric current and is operably connected to the air pump generally shown at 14. The actuator 12 is covered by a casing 16 that is connected to a housing 18 of the air pump 14. The air pump 14 has an inlet 20 and an outlet 22 in which the air flows in and out of the air pump 14 respectfully.

The actuator 12 energizes the air pump 14 causing an impeller 24 to rotate and cause air to flow through the inlet 20 and outlet 22. It is understood, however, that a pumping fan or other mechanism can be used as an alternative to the impeller 24.

The pulse width modulated controller 26 is connected to a battery 28 and receives energy from the battery 28. It is understood, however, that any conventional energy source can be used. The pulse width modulated controller 26 is operably connected to the actuator 12 and controls the amount of voltage applied to the actuator 12. The air flow generated by the air pump 14 corresponds with the amount of voltage applied to the actuator 12 by the pulse width modulated controller 26. The in-rush current experienced by the actuator 12 can be controlled to be less than or equal to 150 amps. when the actuator 12 is initially activated. However, the current range can vary depending on the needs of a particular application.

A pump relay 30 is coupled to or integrated with the pulse width modulated controller 26 and operably connected to the actuator 12. The pump relay 30 receives a signal from an electronic control unit 32 and acts as an on/off switch for allowing the application of voltage and flow of current to the actuator 12. However, it is not necessary for the pump relay 30 to be present for the pulse width modulated controller 26 to control the amount of voltage applied to the actuator 12.

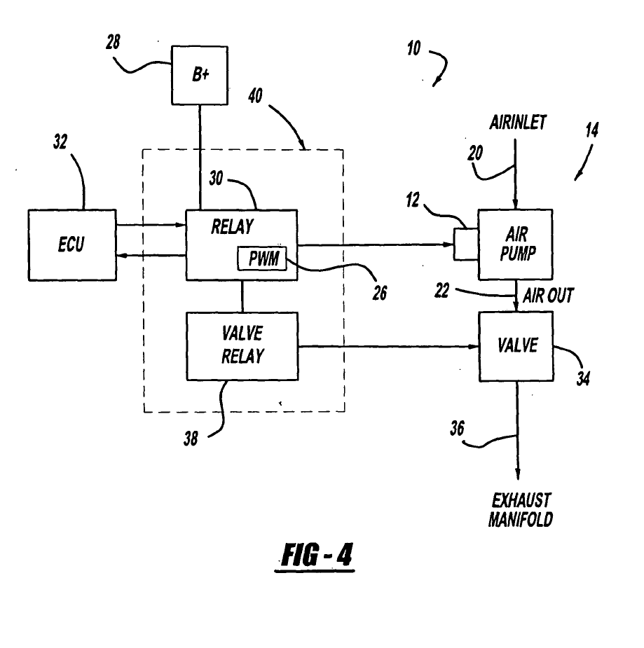

A valve 34, as shown in FIG. 4, is operably connected to the outlet 22 of the air pump 14 for controlling the flow of air to the engine's exhaust manifold 36. A valve relay 38 is operably connected to the valve 34 and acts as an on/off switch to energize the valve 34. The valve relay 38 can be coupled to the pulse width modulated controller 26 and the pump relay 30, generally shown at 40, however, the valve relay 38 controls the activation of the valve 34.

Referring to FIG. 1, one secondary air supply arrangement 10 includes the pulse width modulated controller 26 located remotely from a secondary air supply device 42. Electric current from the battery 28 flows through a connection to the pulse width modulated controller 26. The pulse width modulated controller 26 applies a pulse width modulated voltage to the actuator 12 either through the pump relay 30 or directly. The actuator 12 energizes the air pump 14 causing air to flow through the inlet 20 and outlet 22 respectfully.

The pulse width modulated controller 26 and the pump relay 30 can alternatively be coupled to or integrated with the electronic control unit 32 located remotely from the secondary air supply device 42. The pulse width modulated controller 26 applies a pulse width modulated voltage to the actuator 12 either through the pump relay 30 or directly.

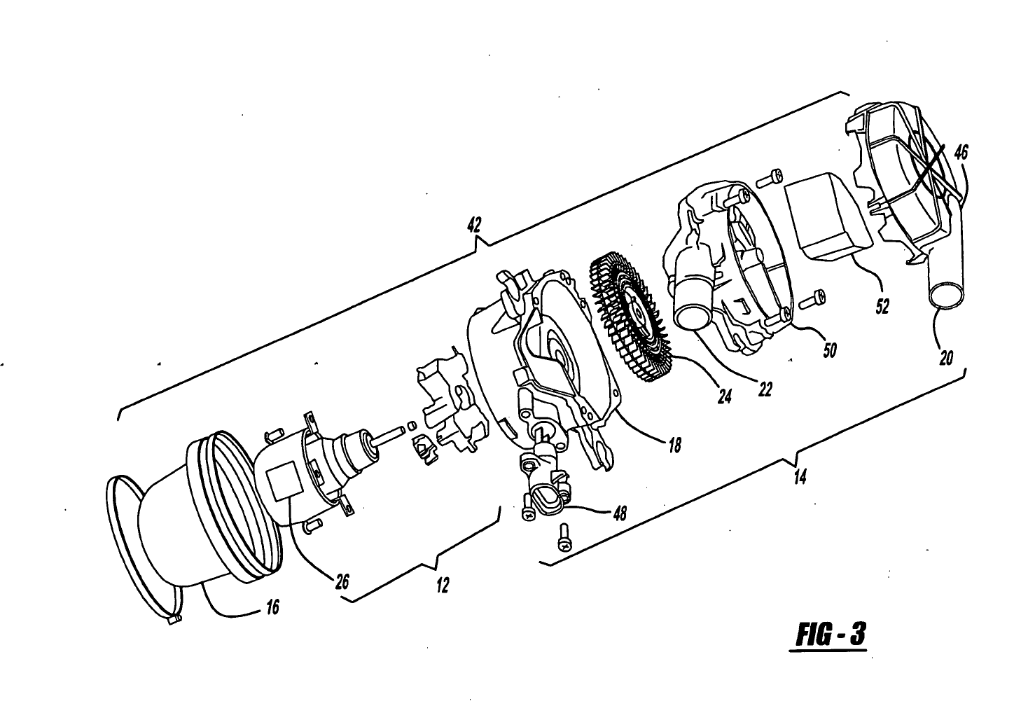

Referring to FIG. 2, an alternative secondary air supply arrangement 10 includes the pulse width modulated controller 26 as a solid state device connected on a top of a cover 46 of the air pump 14. However, it is understood that the pulse width modulated controller 26 can be connected anywhere on the outside of the secondary air supply arrangement 10. Electric current from the battery 28 flows through a connection to the pulse width modulated controller 26. The pulse width modulated controller 26 applies a pulse width modulated voltage to the actuator 12 either through the pump relay 30 or directly.

Referring to FIG. 3, yet another alternative of the secondary air supply arrangement 10 is shown, wherein the pulse width modulated controller 26 is coupled to or integrated with the actuator 12. However, it is understood that the pulse width modulated controller 26 can be integrated anywhere within the secondary air supply device 42. The actuator 12 is operably connected to the air pump 14 for creating air flow between the inlet 20 and outlet 22 of the air pump 14. The housing 18 of the air pump 14 houses the impeller 24 and includes an electrical port 48. A lower flow chamber 50, having the outlet 22, is connected to the housing 18 and houses a particulate filter 52. The cover 46, having the inlet 20, is connected to the lower flow chamber 50. Air flows in and out of the inlet 20 and the outlet 22 of the air pump 14 respectfully.

The battery delivers electric current through the electrical port 48 to the pulse width modulated controller 26. The pulse width modulated controller 26 is operably connected to the actuator 12 and directly controls the voltage applied to the actuator 12. However, it is understood that the pump relay can be coupled to or integrated with the pulse width modulated controller 26, wherein the pulse width modulated controller 26 applies a pulse width modulated voltage to the actuator 12 through the pump relay.

Referring to FIG. 4, a schematic diagram of a secondary air supply arrangement 10 having the valve relay 38 is shown. Electric current commanded by the electronic control unit 32 flows through the connection to the pump relay 30 that is coupled to or integrated with the pulse width modulated controller 26. The pulse width modulated controller 26 applies a pulse width modulated voltage to the actuator generally shown at 12 either through the pump relay 30 or directly. The actuator 12 energizes the air pump generally shown at 14 causing the impeller to rotate and cause air to flow through the inlet 20 and the outlet 22 respectfully. A valve relay 38 is operably connected to the valve 34 and acts as an on/off switch to energize the valve 34 and control the air flow to the engine's exhaust manifold 36. The valve relay 38 can be coupled to the pulse width modulated controller 26 and the pump relay 30, generally shown at 40, however, the valve relay 38 controls the activation of the valve 34.

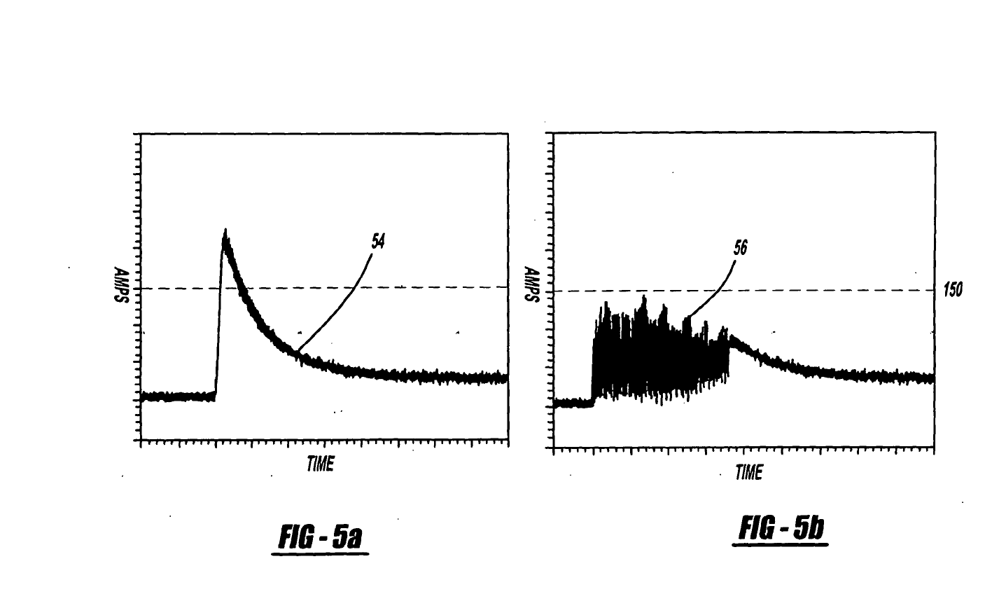

Referring to FIG. 5a, the graph illustrates the in-rush current developed due to activation of the air pump when it is initially activated at the engine's cold start condition until full flow is achieved. A Line 54 depicts the unfavorable condition of the in-rush current exceeding 150 amps. and the pulse width modulated controller is not in use.

Referring to FIG. 5b, Line 56 depicts the in-rush current controlled to less than or equal to 150 amps. when the pulse width modulated controller is used to apply a pulse width modulated voltage to the actuator of the secondary air supply device. The in-rush current can be controlled to be less than or equal to 150 amps. When the actuator is initially energize, however, the specific amperes can vary depending on the needs of a particular application.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A secondary air supply arrangement comprising:
an air pump operable to create air flow between an inlet and an outlet of said air pump;
an actuator operable to energize said air pump; and
a pulse width modulated controller operably connected to said actuator for applying a pulse width modulated voltage to said actuator.

2. The secondary air supply arrangement of claim 1 wherein said pulse width modulated controller is mounted to said air pump.

3. The secondary air supply arrangement of claim 1 further comprising a pump relay coupled to said pulse width modulated controller, wherein said pump relay switches a voltage to said actuator.

4. The secondary air supply arrangement of claim 1 further comprising:
a valve operably connected to said outlet of said air pump;
a valve relay coupled to said pulse width modulated controller and said pump relay, wherein said valve relay controls the activation of said valve.

5. The secondary air supply arrangement of claim 1 wherein said pulse width modulated controller is a solid state device.

6. The secondary air supply arrangement of claim 1 wherein an initial in-rush electric current is controlled when said actuator is activated.

7. The secondary air supply arrangement of claim 6 wherein said in-rush electric current is preferably limited to less than or equal to 150 amps.

8. The secondary air supply arrangement of claim 1 wherein voltage applied by said pulse width modulated controller is commanded by an electronic control unit.

9. A current limiting arrangement comprising;
an electronic control unit;
a pump relay connected to said electronic control unit;
a pulse width modulated controller connected to said pump relay;
a battery connected to said pulse width modulated controller;
an air pump, wherein said air pump is energized by an actuator;
a valve relay coupled to said pump relay and said pulse width modulator controller; and
a valve operably connected to said valve relay.

10. The current limiting arrangement of claim 9 wherein said pulse width modulated controller is a solid state device.

11. The current limiting arrangement of claim 9 wherein said pulse width modulated controller is mounted to a top of said air pump.

12. The current limiting arrangement of claim 9 wherein said pulse width modulated controller is integrated into an actuator, wherein said actuator energizes said air pump.

13. The current limiting arrangement of claim 9 wherein said pulse width modulated controller applies a pulse width modulated voltage to said actuator.

14. The current limiting arrangement of claim 9 wherein an initial in-rush electric current is controlled when said actuator is activated.

15. The current limiting arrangement of claim 14 wherein said in-rush electric current is preferably limited to less than or equal to 150 amps.

16. The current limiting arrangement of claim 9 wherein said valve relay variably controls a position of said valve.

17. A secondary air supply arrangement comprising;
an air pump operable to create air flow between an inlet and an outlet of said air pump;
an actuator operable to energize said air pump;
a pulse width modulated controller operably connected to said actuator for applying a pulse width modulated voltage to said actuator, said pulse width modulated controller being a solid state device;
a pump relay operably connected to said pulse width modulated controller, wherein an electronic control unit commands said pump relay and said pump relay switches electric flow to said actuator;
a valve operably connected to said outlet of said air pump for controlling the flow of air to an engine's exhaust manifold; and
a valve relay coupled to said pulse width modulated controller and said pump relay, wherein said valve relay controls the activation of said valve.

18. The secondary air supply arrangement of claim 17 wherein said pulse width modulated controller is coupled to or integrated with said actuator.

19. The secondary air supply arrangement of claim 17 wherein said pulse width modulated controller is coupled to or integrated with said air pump.

20. The secondary air supply arrangement of claim 17 wherein an initial in-rush electric current is controlled when said actuator is activated.

21. The secondary air supply arrangement of claim 20 wherein said in-rush electric current is preferably limited to less than or equal to 150 amps.
